(19) United States
(12) Patent Application Publication
(10) Pub. No.: US 2003/0058748 A1
(43) Pub. Date: Mar. 27, 2003

(54) Interface apparatus that can reproduce audio data by itself

(76) Inventors: Shintaro Tomitsuka, Yamagata-Shi (JP); Makoto Sato, Yamagata-Shi (JP)

Correspondence Address: Richard J. Streit, c/o Ladas & Parry, Suite 1200, 224 South Michigan Avenue, Chicago, IL, 60604, US

(21) Appl. No.: 10/244,327

(22) Filed: Sep. 16, 2002

(30) Foreign Application Priority Data
Sep. 27, 2001 (JP) 2001-297780

(51) Int. Cl. H04B 1/20; G06F 17/00; G11B 7/00

(52) U.S. Cl. 369/5; 369/124.06; 700/94

(57) ABSTRACT

An interface apparatus is provided that can reproduce compressed audio data stored in a storage unit without activating an external computer connected to the interface apparatus. The interface apparatus includes the storage unit, a communication unit that exchanges data with the computer, an audio reproduction unit that reproduces the audio data retrieved from the storage unit, and a control unit that controls both the communication unit and the audio reproduction unit. Regarding reproduction of compressed audio data, the interface apparatus does not require another control unit dedicated for the reproduction. Accordingly, the area of circuit board required for mounting components can be reduced and the pattern of the circuit board can be simplified.

### BACKGROUND OF THE INVENTION

1. Field of the Invention

The present invention generally relates to an interface apparatus, and more particularly, to an interface apparatus provided with an audio reproduction function.

2. Description of the Related Art

Electronic music distribution (EMD) service, that is, distribution of digital music content via the Internet, has been introduced into the market thanks to recent improvements in the performance and the processing speed of computers, developments in the compression techniques of audio data, and prevalence of Internet access.

Electronic music distribution service of one kind will be described by reference to FIG. 6. The service system showed in FIG. 6 is configured with an EMD server 60 that provides music content, the Internet 61, and a computer 62. The EMD server 60 distributes the music content to the computer 62 via the Internet 61. Using the computer 62, a user can play the music anytime by downloading distributed digital music content into an internal hard disk and playing it with an installed audio decoder.

An interface apparatus 63 to be connected to the computer 62 has proliferated recently. The user can store the digital music contents in an optical disk, a magneto-optical disk, a flash memory, and so forth.

When the user reproduces the compressed audio data stored in the interface apparatus 63 such as a CD-RW drive, the user is required to activate an application program on the computer 62, fetch the compressed audio data that the user desires to reproduce, and decode the fetched audio data. The problem is that the user has to spend time to start the computer 62 whenever the user reproduces the audio data.

The interface apparatus 63 according to the conventional technique has a function to store the digital music contents, as is, in a recording medium, but it supports only a specific audio compression method. For example, in the case of an MP3 player, because it decodes and converts MP3 data into audio data by a dedicated decoder, it cannot handle digital music contents encoded by an audio compression method other than the MP3 method.

### SUMMARY OF THE INVENTION

Accordingly, it is an object of the present invention to provide a novel and useful interface apparatus by which the problem described above is eliminated.

Another and more specific object of the present invention is to provide an interface apparatus that can reproduce audio data without activating a computer to which the interface apparatus is connected.

Yet another object of the present invention is to provide an interface apparatus that supports various audio compression methods.

To achieve one of the above objects, an interface apparatus according to the present invention includes a communication unit that exchanges data with an exterior in compliance with a predetermined interface standard, a storage unit that stores therein audio data received by said communication unit, an audio reproduction unit that reproduces said audio data stored in said storage unit, and a control unit that controls both said communication unit and said audio reproduction unit.

The interface apparatus according to the present invention can reproduce compressed audio data without activating an external computer connected to the interface apparatus. Upon reproduction of compressed audio data, the interface apparatus does not require another control unit dedicated for the reproduction, that is, the control unit can control both the interface unit and the audio reproduction unit. Accordingly, the area of circuit board required for mounting components can be reduced and the pattern of the circuit board can be simplified. Additionally, if a plurality of audio decoders is further provided in the audio reproduction unit, the interface apparatus can decode and reproduce various types of compressed audio data.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing an interface apparatus according to an embodiment of the present invention and the electronic music distribution service system;

FIG. 2 is a block diagram showing an interface apparatus according to an embodiment of the present invention;

FIG. 3 is a block diagram showing an interface apparatus according to another embodiment of the present invention;

FIG. 4 is a block diagram showing an interface apparatus according to yet another embodiment of the present invention;

FIG. 5 is a block diagram showing an interface apparatus according to a variation of the embodiment of the present invention showed in FIG. 2; and

FIG. 6 is a schematic diagram showing an interface apparatus according to the conventional technique and the electronic music distribution service system.

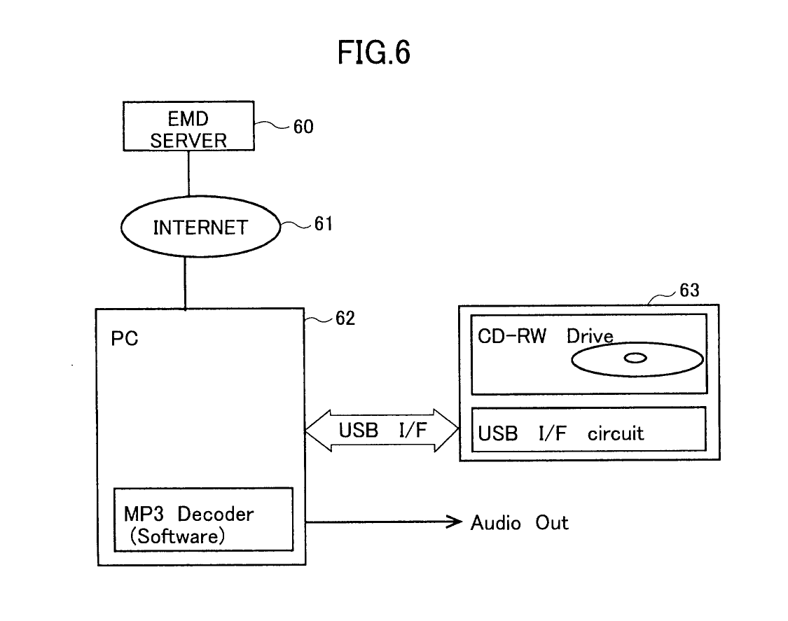

### DETAILED DESCRIPTION OF THE PREFERRED EMBODIMENTS

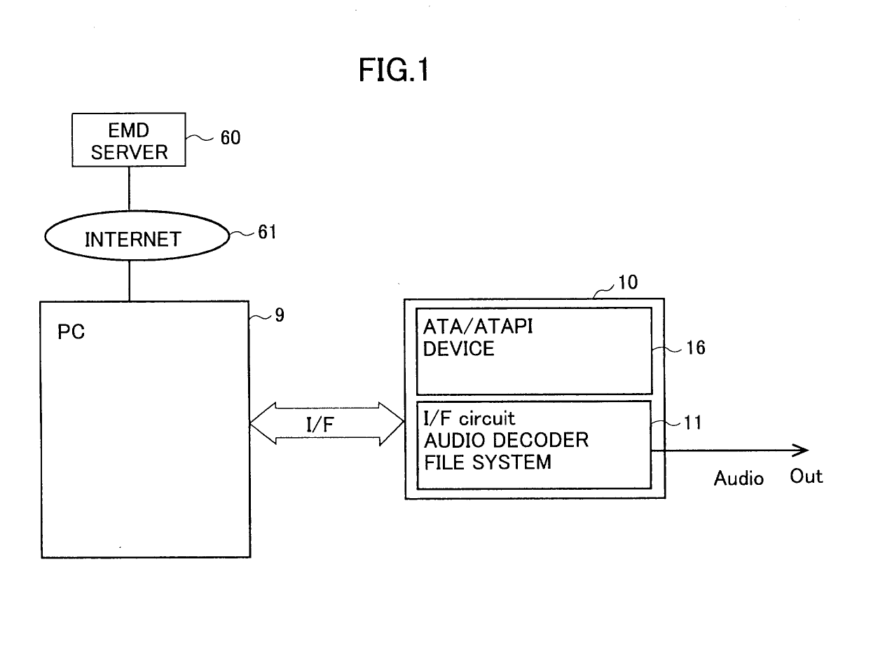

The preferred embodiments of the present invention will be described in detail by reference to the drawings. FIG. 1 is a schematic diagram that is convenient for describing an interface apparatus according to an embodiment.

As showed in FIG. 1, a computer 9 is connected to an EMD server 60 via the Internet 61, and an interface apparatus 10 is connected to the computer 9 via an interface. The interface apparatus 10 is mainly configured with an interface unit 11 and an ATA/ATAPI device 16. What is different from the conventional interface apparatus is that an audio decoder and a file system are provided in the interface apparatus 10.

This interface unit 11 functions as both an interface that enables the interface unit 11 to communicate with the computer 9 and an audio reproduction unit that directly reproduces audio data stored in a recording medium even without connecting the interface apparatus 10 to the computer 9.

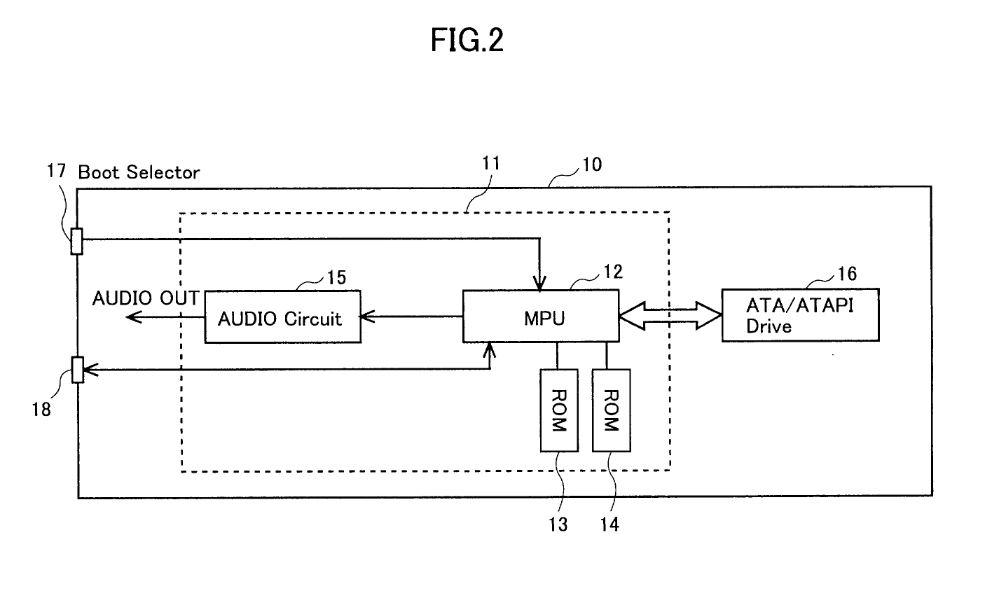

The interface apparatus 10 will be described in more detail by reference to FIGS. 2-5. FIG. 2 is a block diagram showing the interface apparatus 10 according to an embodiment. As showed in FIG. 2, the interface apparatus 10 includes the interface unit 11, MPU 12, ROM 13 and 14. An audio circuit 15, the ATA/ATAPI device 16, a boot selector 17, and a port 18 are connected to the MPU 12.

The interface apparatus 10 records and reproduces audio data, and communicates with the computer 9 through a communication cable and the like. The interface apparatus 10 is categorized by the drive provided therein such as a CD-R device, a CD-RW device, a DVD-RW device, or a HDD device.

The MPU (Micro Processing Unit) 12 is a one-chip microcomputer with an embedded CPU core, and controls the interface to the computer 9 and the reproduction of the audio data. In the case where the interface apparatus 10 communicates with the computer 9, the MPU 12 functions as an interface controller. When the interface apparatus 10 reproduces the audio data, the MPU 12 functions as an audio reproduction controller. Additionally, in the case the MPU 12 functions as the interface controller for the connection with the computer 9, the MPU 12 can handle various transmission methods such as USB, IEEE 1394, IEC 958, Serial Port, Parallel Port, and SCSI.

ROM 13 stores therein a computer program beforehand that causes MPU 12 to function as the interface controller. On the other hand, ROM 14 stores therein a computer program that causes MPU 12 to function as the audio reproduction controller. In this embodiment, ROM 13 and 14 are provided separately, however, the above computer programs may be stored in a single ROM.

The audio circuit 15 is configured by an audio decoder (to be described later), a DAC, and so forth. The ATA (IDE) or ATAPI device 16 is a storage device such as a CD-R device, a CD-RW device, a DVD-RW device, an MO device, and a HDD device. ATA (AT attachment) is the standard of interface that is defined by ANSI based on the IDE interface, an interface for a hard disk drive used for PC compatibles. Likewise, ATAPI (Advanced Technology Attachment Packet Interface) is the standard of interface to connect a storage device other than a hard disk, such as a CD-ROM drive and a tape streamer, to the ATA interface.

Additionally, the ATA/ATAPI device 16 is provided with a recording head that directly records and reproduces data on the recording medium, a head actuator, a read/write unit that processes the data for recording and reproduction, and so forth (not shown).

The boot selector 17 is used to switch the functions of the interface apparatus 10. The interface apparatus 10 is switched to function as either an interface unit or an audio unit by the boot selector 17. In this embodiment, a switch functioning as the boot selector 17 is provided on the outer case of the interface apparatus 10. In another embodiment, the boot selector 17 may be implemented as a remote controller that transmits a boot select signal to the MPU 12.

A communication cable is connected to the port 18 so that the computer 9 and the interface apparatus 10 can communicate.

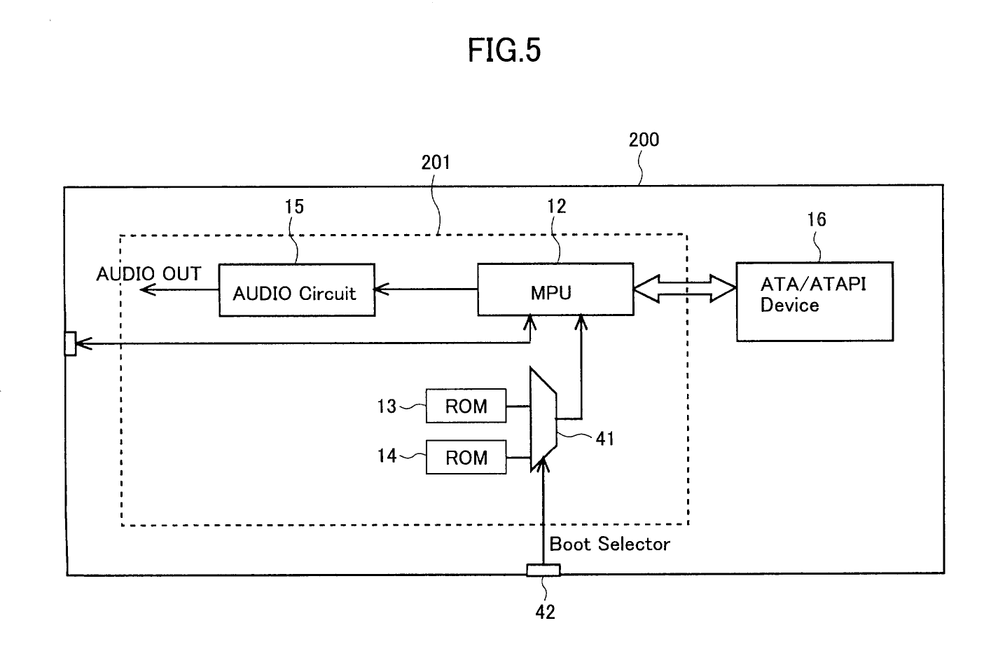

FIG. 5 is a block diagram showing a variation of the interface apparatus showed in FIG. 2. As showed in FIG. 5, ROMs 1 and 2 are connected to the MPU 12 via an address decoder 41. A selection signal in response to an operation of the boot selector 42 is input to the address decoder 41 so that the MPU 12 can detect the selection signal.

### EXAMPLE 1

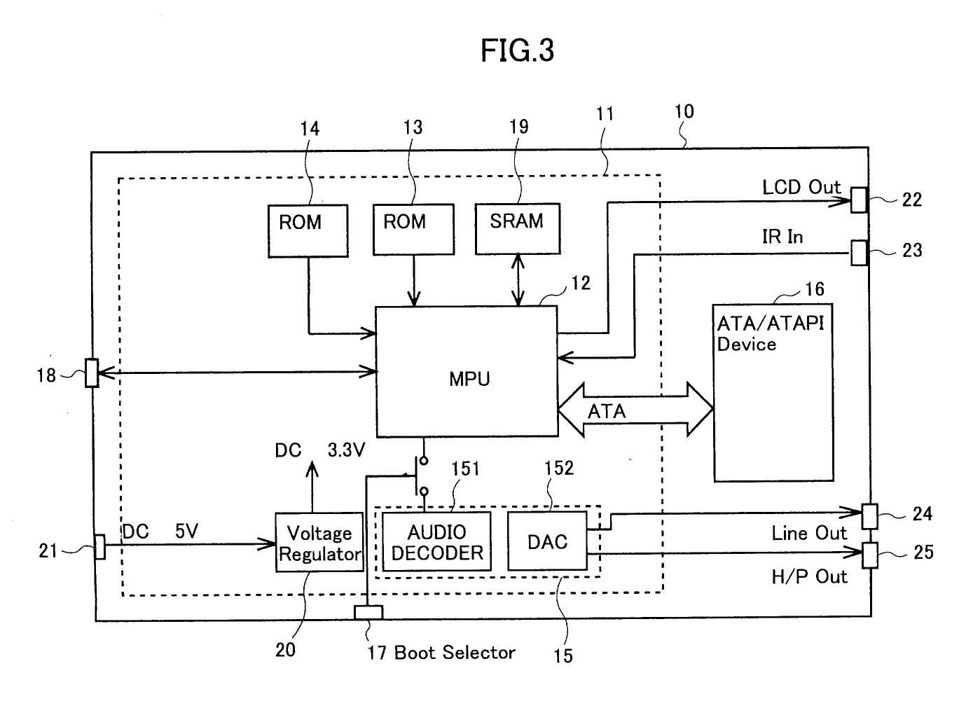

An example of the interface apparatus according to the present invention will be described below. FIG. 3 is a block diagram showing an interface apparatus according to this example. As showed in FIG. 3, the interface apparatus 10 includes the following: an interface unit 11, an MPU 12, ROMs 13 and 14, an SRAM (Static Random Access Memory) 19, a voltage regulator 20, an external power supply connection unit 21, an LCD (Liquid Crystal Display) 22, an infrared photo detection unit 23, a speaker terminal 24, and a headphone terminal 25. An audio circuit 15, an ATA/ATAPI device 16, a boot selector 17, and a port 18 are connected to the MPU 12.

The audio circuit 15 is configured by an audio decoder 151 and a DAC (Digital Analog Converter) 152. The audio decoder 151 decodes compressed audio data such as MP3 data to original PCM digital audio data. If the audio data are compressed as ATRAC 3 data or TwinVQ data instead of MP3 data, a dedicated ATRAC 3 decoder or a dedicated TwinVQ decoder, respectively, can be used as the audio decoder 151.

The DAC 152 converts digital audio data decoded by the audio decoder (MP3 decoder, for example) into an analog audio signal. Because the DAC 152 is provided with an embedded amplifier, it can directly drive the speaker terminal 24 and the headphone terminal 25.

The SRAM 19 provides the MPU 12 with a working memory area and temporarily stores therein data generated by the MPU 12. The voltage regulator 20 converts the voltage of 5V provided from the exterior through the external power supply connection terminal 21 into 3.3V and provides the regulated voltage to the internal circuit. The LCD 22 displays various items of information such as the number of a music piece, a time counter, and a volume label.

The infrared photo detection unit 23 receives an infrared signal transmitted by the remote controller to remote control the interface apparatus 10. The speaker output terminal 24 and the headphone output terminal 25 output the signal reproduced by the audio decoder 151 and the DAC 152 to the exterior. A speaker and a headphone are to be respectively connected to convert the reproduced signal into sound.

The cases where the interface apparatus 10 functions as an interface apparatus and an audio apparatus will be described below. It is assumed in the following description that the computer 9 and the interface apparatus 10 are connected via the USB interface and the ATA/ATAPI device is a CD-R/W drive. It is further assumed that audio data compressed by the MP3 method are recorded in the CD-RW disk and decoded by the audio decoder.

(1) Interface Mode

When the interface apparatus 10 is used as a USB interface apparatus (interface mode), the port 18 of the interface apparatus 10 is connected to the computer 9 via a communication cable. The MPU 12 automatically detects that the interface mode has been selected. The MPU 12 loads a computer program for the interface mode from ROM 13 and functions as a USB controller.

In this interface mode, the user can use the interface apparatus 10 as an ordinary CD-RW device that exchanges data with the computer 9.

As showed in FIG. 1, in the case where audio data are to be recorded in a CD-RW disk, the digital music contents are distributed from the EMD server 60 via the Internet. The computer 9 downloads the digital music contents distributed by the EMD server 60 into an internal hard disk and encodes so as to compress the downloaded music data using dedicated MP3 encoder software.

The computer 9 serially transmits the MP3 data to the interface apparatus 10 through the communication cable. On the other hand, the MPU 12 reconstructs the MP3 data based on serially transmitted data received from the computer 9 and stores the reconstructed MP3 data in the CD-RW disk set in the CD-RW device 16 as digital data. The digital data recorded in the CD-RW disk can be erased and recorded by the computer 9 via the operation of the MPU 12.

(2) Audio Mode

When the function of the interface apparatus 10 is to be switched from the interface mode to the audio reproduction function (audio mode), the audio reproduction function is to be selected by the operation of the boot selector 17 provided on the external case of the interface apparatus 10. In response to detection that the audio mode is selected, the MPU 12 loads and runs the computer program for audio reproduction stored in the ROM 14 so that the MPU 12 functions as an audio reproduction controller.

When the MPU 12 receives an instruction of reproduction from the remote controller through the infrared photo detecting unit 23, the MPU 12 activates the CD-RW drive to fetch data recorded in the CD-RW disk via an ATAPI interface. The MPU 12, in response to a request for data by the audio decoder 151, transmits the requested data to the audio decoder 151 to decode the data. The clock signal required for the decoding is also transmitted by the MPU 12 to the MP3 decoder 151.

Decoded data are transferred from the audio decoder 151 to the DAC 152 with the clock signal and converted from digital data to an analog signal for amplification. The amplified analog signal is sent to either the speaker terminal 24 or the headphone terminal 25. The amplified analog signal is provided from the speaker terminal 24 to a speaker unit or from the headphone terminal 25 to a headphone to reproduce music.

Additionally, in one embodiment, the audio decoder 151 is a hardware decoder. In another embodiment, the audio decoder 151 may be a computer program, such as the MP3 decoder, running on the MPU 12 of which decoding algorithm corresponds to the encoding algorism.

Accordingly, though the interface apparatus 10 is not provided with separate MPUs, one dedicated for the interface unit and another dedicated for the audio reproduction unit, a single MPU (controller) can perform the interface function (interface mode) and the audio reproduction function (audio mode)

### EXAMPLE 2

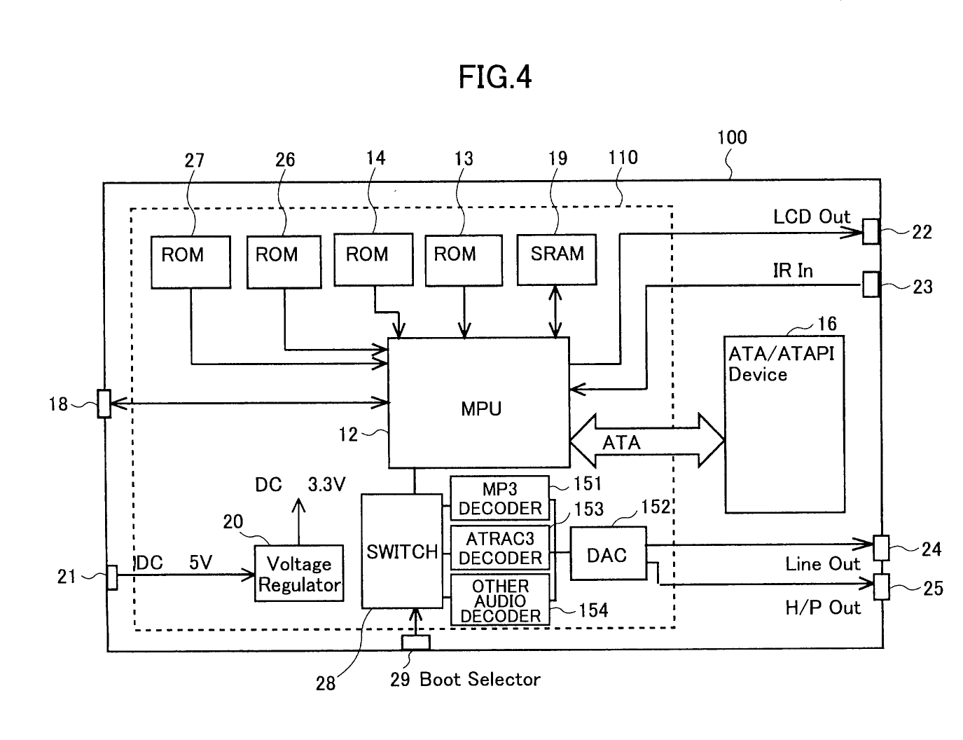

Another example of the interface apparatus according to the embodiment will be described in detail below. FIG. 4 is a block diagram showing the second example of the interface apparatus according to an embodiment. The same components as those described above in connection with the first example are referred to by the same numerals and descriptions of them are omitted.

As showed in FIG. 4, an interface apparatus 100 according to this example is provided with the following: a ROM 26 in which a computer program for the reproduction of ATRAC3 data is stored, a ROM 27 in which a computer program for the reproduction of audio data is stored, an ATRAC3 decoder 153, another audio decoder 154, a switch 28 for selecting a decoder, and a boot selector 29 with which multiple audio data are selectable. An interface unit 110 is configured so that, even if multiple types of audio data are recorded in the recording medium, the interface apparatus 100 can reproduce the audio data.

The switch 28 is for switching the decoder among the MP3 decoder 151, the ATRAC3 decoder 153, or the other audio decoder. When the user selects certain audio data by the boot selector 29, this switch 28 selects the decoder corresponding to the selected audio data. The MPU 12 detects the switching of the decoders by the switch 28, and loads necessary computer programs from ROM 14, 26, and 27, and runs the computer programs. Accordingly, the MPU 12 functions as an audio reproduction controller and the interface apparatus 100 functions as an audio reproduction unit.

The case where the interface apparatus 100 functions as an audio reproduction unit will be described below. It is assumed in this description that the audio data recorded in the CD-RW disk are ATRAC3 data.

When a user desires to use the interface apparatus 100 as an audio reproduction unit in this case, the user is required to select the ATRAC3 reproduction function by the boot selector 29. The MPU 12 determines that the ATRAC3 reproduction function is selected by observing the switch 29, and loads the computer program for the ATRAC3 reproduction stored in the ROM 27 followed by the execution of the computer program. Accordingly, the MPU 12 functions as a controller for the reproduction of the ATRAC3 data.

In response to reception of the instruction for reproduction from the remote controller via the infrared photo detection unit 23, the MPU 12 activates the CD-RW device and fetches data recorded in the CD-RW disk set in the CD-RW device via ATAPI interface.

In response to reception of a request for data from the ATRAC3 decoder 153, the MPU 12 transmits the requested data to the ATRAC3 decoder 153 so as to decode the requested data by the ATRAC3 decoder 153. The clock signal to be used for the decoding is transmitted from the MPU 12 to the ATRAC3 decoder 153 at the same time. In this manner, the decoded data are transferred from the ATRAC3 decoder 153 to the DAC 152 with the clock signal, are converted from the digital data to an analog signal, and amplified. The amplified analog signal is output to either the speaker terminal 24 or the headphone terminal 25, and further provided to a speaker unit through the speaker terminal and to a headphone through the headphone terminal 25 so as to reproduce sound.

Accordingly, the interface apparatus 100 can reproduce the audio data without activating the computer 9. The interface apparatus 100 does not require a dedicated controller even for the reproduction of compressed audio data. That is, the area of the circuit board required for mounting components can be reduced and the circuit pattern can be simplified.

As is clear based on what has been described above, an interface apparatus according to an aspect of the present invention can reproduce audio data without activating the computer connected to the interface apparatus. An interface apparatus according to another aspect of the present invention does not require a dedicated controller for the reproduction of the audio data. Additionally, an interface apparatus according to yet another aspect of the present invention can support various types of audio data.

The preferred embodiments of the present invention are described above. The present invention is not limited to these embodiments, but various variations and modifications may be made without departing from the scope of the present invention.

This patent application is based on Japanese priority patent application No. 2001-297780 filed on Sep. 27, 2001, the entire contents of which are hereby incorporated by reference.

What is claimed is:

1. An interface apparatus, comprising:
a communication unit that exchanges data with an exterior in compliance with a predetermined interface standard;
a storage unit that stores therein audio data received by said communication unit;
an audio reproduction unit that reproduces said audio data stored in said storage unit; and
a control unit that controls both said communication unit and said audio reproduction unit.

2. The interface apparatus as claimed in claim 1, further comprising a switching unit that selects one of said communication unit and said audio reproduction unit wherein the selected one is controlled by said control unit.

3. The interface apparatus as claimed in claim 1, wherein said audio reproduction unit further comprises an audio decoder that decodes and decompresses compressed audio data.

4. The interface apparatus as claimed in claim 2, wherein said audio reproduction unit further comprises an audio decoder that decodes and decompresses compressed audio data.

5. The interface apparatus as claimed in claim 1, wherein said audio reproduction unit further comprises a plurality of audio decoders, each of which decodes and decompresses compressed audio data.

6. The interface apparatus as claimed in claim 2, wherein said audio reproduction unit further comprises a plurality of audio decoders, each of which decodes and decompresses compressed audio data.

7. The interface apparatus as claimed in claim 1, wherein said audio data are encoded and compressed in compliance with the MP3 standard.

8. The interface apparatus as claimed in claim 2, wherein said audio data are encoded and compressed in compliance with the MP3 standard.

9. The interface apparatus as claimed in claim 3, wherein said audio data are encoded and compressed in compliance with the MP3 standard.

10. The interface apparatus as claimed in claim 4, wherein said audio data are encoded and compressed in compliance with the MP3 standard.
